(19) United States
(12) Patent Application Publication
(10) Pub. No.: US 2024/0419152 A1
(43) Pub. Date: Dec. 19, 2024

(54) REGISTRATION APPARATUS, REFERENCE APPARATUS, REGISTRATION METHOD, REFERENCE METHOD, COMPUTER READABLE MEDIUM, MANAGEMENT SYSTEM, AND MANAGEMENT METHOD

(71) Applicant: Noboru Nagatani

(72) Inventor: Noboru Nagatani

(21) Appl. No.: 18/274,131

(22) PCT Filed: Jan. 28, 2021
(86) PCT No.: PCT/JP2021/003115

§ 371 Date: Jul. 25, 2023

(51) Int. Cl. G05B 19/418

(52) U.S. Cl. CPC G05B 19/4184; G05B 19/4183

(57) ABSTRACT

A registration apparatus (2100) acquires product identification information, which is identification information of a product to be registered, item identification information, which is identification information of an item related to a manufacturing process, and manufacturing process information related to the item corresponding to the acquired item identification information among the manufacturing process information related to the manufacturing process of the product. The registration apparatus (2100) computes a digest value of the acquired manufacturing process information. The registration apparatus (2100) puts the computed digest value in a storage unit (2300) in association with the acquired product identification information and the acquired item identification information.

### DESCRIPTION

### Technical Field

The present disclosure relates to management of information related to manufacture of products.

### Background Art

Various information about a manufacturing process of a product is used to assure the quality of the product. For example, a record of each inspection performed during the manufacturing process of the product and a record of an audit performed to verify the manufacturing process are used. For example, Patent Literature 1 discloses a management system for registering audit trails showing the content of and reasons for configuration changes when configuration changes are made for pharmaceutical, beverage, or food manufacturing equipment.

### CITATION LIST

### Patent Literature

### Patent Literature 1: Japanese Unexamined Patent Application Publication No. 2019-220127

### SUMMARY OF INVENTION

### Technical Problem

One of objects of the present disclosure is to provide a new technique for managing information about a manufacturing process of a product.

### Solution to Problem

A registration apparatus according to the present disclosure includes: an acquiring unit configured to acquire identification information of a product to be registered, identification information of an item related to a manufacturing process, and manufacturing process information related to the item among the manufacturing process information related to the manufacturing process of the product; and a saving unit configured to compute a digest value of the acquired manufacturing process information, and put the computed digest value in a storage unit in association with the acquired identification information of the product and the acquired identification information of the item.

A reference apparatus according to the present disclosure is communicably connected to a storage unit, the storage unit storing, in association with identification information of a product and identification information of an item related to a manufacturing process, a digest value of the manufacturing process information related to the item among the manufacturing process information related to the manufacturing process of the product. The reference apparatus includes: an acquiring unit configured to acquire the identification information of the product to be referenced; and an outputting unit configured to output reference information by which it can determine, for one or more of the items, whether or not the digest value of the manufacturing process information is stored in the storage unit in association with the identification information of the item and the identification information of the product to be referenced.

A registration method according to the present disclosure is executed by a computer. The registration method includes: an acquiring step of acquiring identification information of a product to be registered, identification information of an item related to a manufacturing process, and manufacturing process information related to the item among the manufacturing process information related to the manufacturing process of the product; and a saving step of computing a digest value of the acquired manufacturing process information and putting the computed digest value in a storage unit in association with the acquired identification information of the product and the acquired identification information of the item.

A reference method according to the present disclosure is executed by a computer. The computer is communicably connected to a storage unit, the storage unit storing, in association with identification information of a product and identification information of an item related to a manufacturing process, a digest value of the manufacturing process information related to the item among the manufacturing process information related to the manufacturing process of the product. The control method includes: an acquiring step of acquiring the identification information of the product to be referenced; and an outputting step of outputting reference information by which it can determine, for one or more of the items, whether or not the digest value of the manufacturing process information is stored in the storage unit in association with the identification information of the item and the identification information of the product to be referenced.

A first computer readable medium according to the present disclosure stores a program that causes a computer to execute the registration method according to the present disclosure.

A second computer readable medium according to the present disclosure stores a program that causes a computer to execute the reference method according to the present disclosure.

A management system according to the present disclosure includes the above registration apparatus and the above reference apparatus.

A management method according to the present disclosure is executed by the management system according to the present disclosure.

The registration apparatus acquires identification information of a product to be registered, identification information of an item related to a manufacturing process, and manufacturing process information related to the item among the manufacturing process information related to the manufacturing process of the product; and compute a digest value of the acquired manufacturing process information, and put the computed digest value in a storage unit in association with the acquired identification information of the product and the acquired identification information of the item.

The reference apparatus acquires the identification information of the product to be referenced, and outputs output reference information by which it can determine, for one or more of the items, whether or not the digest value of the manufacturing process information is stored in the storage unit in association with the identification information of the item and the identification information of the product to be referenced.

### Advantageous Effects of Invention

According to the present disclosure, a new technique for managing information about a manufacturing process of a product is provided.

### BRIEF DESCRIPTION OF DRAWINGS

FIG. 1 is a block diagram showing an example of an overview of an operation of a management system according to a first example embodiment;

FIG. 2 is a block diagram showing an example of a functional configuration of the management system according to the first example embodiment;

FIG. 3 is a block diagram showing an example of a hardware configuration of a computer implementing a registration apparatus;

FIG. 4 is a flowchart showing an example of a flow of processing executed by the registration apparatus according to the first example embodiment;

FIG. 5 shows an example of a screen for specifying information to be registered using the registration apparatus;

FIG. 6 shows an example of registration information in a table format;

FIG. 7 is a flowchart showing an example of a flow of processing executed by a reference apparatus according to the first example embodiment;

FIG. 8 shows an example of reference information;

FIG. 9 shows an example of a use case of the management system;

FIG. 10 is a first diagram showing an example of a screen provided by the reference apparatus;

FIG. 11 is a second diagram showing an example of the screen provided by the reference apparatus; and

FIG. 12 is a third diagram showing an example of the screen provided by the reference apparatus.

### EXAMPLE EMBODIMENT

Example embodiments of the present disclosure are described in detail below with reference to the drawings. In the drawings, the same or corresponding elements are given the same symbols, and repeated descriptions are omitted as necessary for clarity. Unless otherwise explained, previously defined values such as predetermined values and thresholds are stored in advance in a memory apparatus or the like accessible from a device using the values. Also, unless otherwise explained, a storage unit is implemented by one or more memory apparatuses.

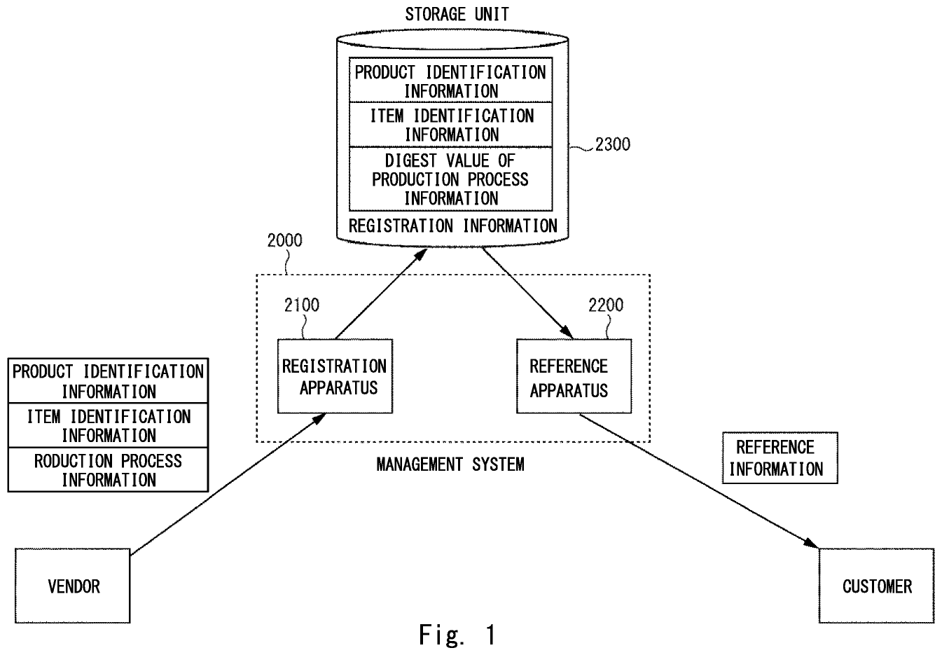

FIG. 1 shows an example of an overview of an operation of a management system 2000 according to a first example embodiment.

Here, FIG. 1 is a diagram to facilitate understanding of the overview of the management system 2000, and the operation of the management system 2000 is not limited to that shown by FIG. 1.

The management system 2000 handles various pieces of information about a manufacturing process of a product (hereinafter, referred to as manufacturing process information). Details about the manufacturing process information will be described later. The management system 2000 has a registration apparatus 2100 and a reference apparatus 2200. The registration apparatus 2100 is used by, for example, an entity (such as a vendor of a product) involved in the manufacture of the product. On the other hand, the reference apparatus 2200 is used by, for example, an entity (such as a customer) that has already been using or is considering using the product. The registration apparatus 2100 and the reference apparatus 2200 are communicably (e.g., via a network) connected to a storage unit 2300. The storage unit 2300 is a storage area configured with one or more storage devices. The registration apparatus 2100 may be used by a customer or the like, and the reference apparatus 2200 may be used by a vendor or the like. For example, a customer may use the registration apparatus 2100 to register information about a product while the product is in operation. A vendor or the like may refer to the registered information for internal auditing or the like.

The manufacturing process information is generated and managed for each product and for each item related to the manufacturing process. The item referred to here is information representing about which product the manufacturing process information is. For example, assume that one piece of the manufacturing process information of a product A is manufacturing procedure manual data that describes a manufacturing procedure for the product A. In this case, for example, the item would be a “manufacturing procedure manual”.

The registration apparatus 2100 registers a digest value (hash value, etc.) of the manufacturing process information in association with the product and the item. For this purpose, the registration apparatus 2100 acquires 1) identification information of a product to be registered, 2) identification information of an item, and 3) manufacturing process information of the product to be registered, which corresponds to the above item. Hereinafter, the identification information of the product is denoted as “product identification information” and the identification information of the item is denoted as “item identification information”.

For example, as described above, assume that one of pieces of the manufacturing process information of the product A is the manufacturing procedure manual data describing a manufacturing procedure of the product A. In this case, the registration apparatus 2100 acquires 1) the product identification information of the product A, 2) the item identification information indicating the item of the manufacturing procedure manual, and 3) the manufacturing procedure manual data of the product A (manufacturing process information).

Furthermore, the registration apparatus 2100 computes a digest value of the acquired manufacturing process information, associates the digest value with the acquired product identification information and item identification information, and puts it in the storage unit 2300. For example, in the above example, the digest value of the manufacturing procedure data of the product A is put in the storage unit 2300 in association with the product identification information of the product A and the item identification information indicating the item “manufacturing procedure manual”. Hereinafter, the information including the association between the “digest value of product identification information, item identification information, and manufacturing process information” stored in the storage unit 2300 is referred to as registration information.

The reference apparatus 2200 is used to reference the information stored in the storage unit 2300. In order to do so, the reference apparatus 2200 acquires the product identification information of the product to be referenced. Next, the reference apparatus 2200 outputs reference information corresponding to the item and the product to be referenced for one or more items. The reference information corresponding to a certain product and a certain item is information that enables to determine whether or not the product identification information of that product and the digest value of the manufacturing process information corresponding to the item identification information of that item are stored in the storage unit 2300.

### Example of Advantageous Effect

For customers who want to select the products they use, it is important to understand the quality of the products. For example, some customers define certain procurement standards in advance and only employ products that meet those procurement standards. Therefore, it is desirable to be able to provide customers with information that enables them to know the quality of products.

In this regard, the manufacturing process information can be used as information to assure the quality of products regarding matters related to the manufacturing process of the products. For example, by using the manufacturing process information indicating an inspection record of a product, the customer can know that the product is of high quality with the correct inspection.

On the other hand, it is sometimes difficult to disclose inspection records, audit records, and so on. Therefore, even if it is not possible to disclose the manufacturing process information itself, it is preferable to make it possible to acquire the quality of the product to a certain extent regarding matters related to the manufacturing process of the product.

According to the management system 2000 of this example embodiment, the registration apparatus 2100 puts the digest value of the manufacturing process information in the storage unit 2300 in association with the identification information of the product and the identification information of the item. In addition, the reference apparatus 2200 provides information that enables to determine whether or not the digest value of the manufacturing process information is stored in the storage unit 2300 in association with the product and item for one or more items with respect to the product to be referenced.

Here, if it is found that the digest value of the manufacturing process information is stored in the storage unit 2300 in association with the product and item, it is possible to know the existence of the manufacturing process information for the item of the product even if the manufacturing process information itself cannot be obtained. For example, even if the contents of the inspection record of the product cannot be browsed, the existence of the inspection record of the product can be grasped. This enables the customer to know the quality of the product to a certain extent. In addition, when the vendor modifies the product process information, the digest value of the modified manufacturing process information no longer matches the digest value of the manufacturing process information stored in the storage unit 2300. Therefore, it is possible to prevent the manufacturing process information from being conveniently modified later.

The management system 2000 according to this example embodiment will be described in more detail below.

### Example of Functional Configuration

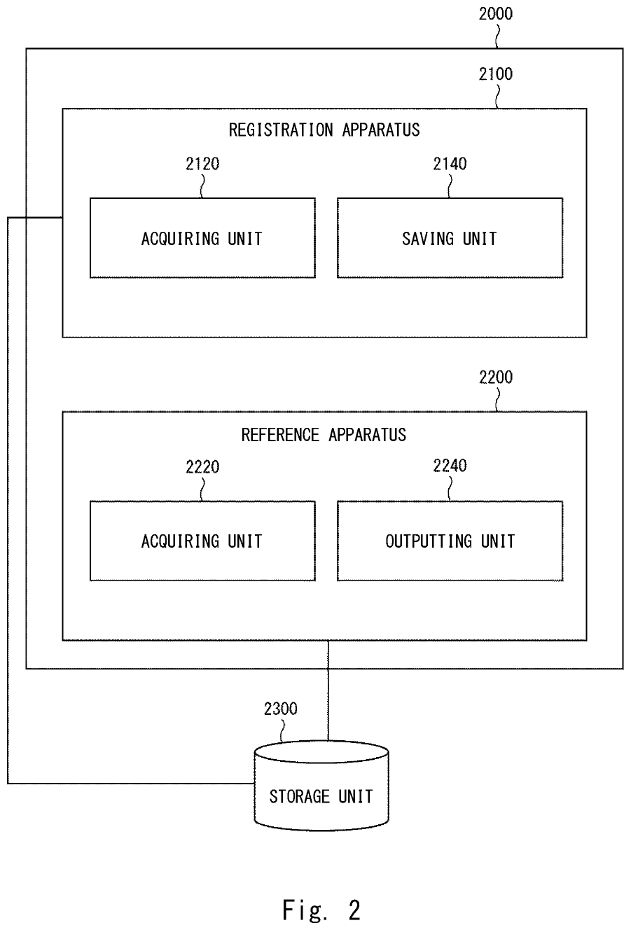

FIG. 2 is a block diagram showing a functional configuration of the management system 2000 according to the first example embodiment. The management system 2000 has the registration apparatus 2100 and the reference apparatus 2200. The registration apparatus 2100 has an acquiring unit 2120 and a saving unit 2140. The acquiring unit 2120 acquires: the product identification information of the product to be registered; the item identification information of the item related to a manufacturing process; and the manufacturing process information related to the above item among the manufacturing process information related to the manufacturing process of the product to be registered. The saving unit 2140 computes a digest value of the acquired manufacturing process information. Next, the saving unit 2140 associates the computed digest value with the acquired product identification information and item identification information, and puts it in the storage unit 2300.

The reference apparatus 2200 has the acquiring unit 2120 and the saving unit 2140. The acquiring unit 2120 acquires the product identification information of the product to be referenced. The saving unit 2140 outputs the reference information of the product to be referenced and the item, for one or more items.

### Example of Hardware Configuration

Each of the functional components of the registration apparatus 2100 and the reference apparatus 2200 may be implemented by hardware (e.g., hardwired electronic circuit, etc.) that implements each functional component, or by a combination of hardware and software (e.g., combination of an electronic circuit and a program that controls it, etc.). The case where each of the functional components of the registration apparatus 2100 and the reference apparatus 2200 is implemented by a combination of hardware and software will be further described below.

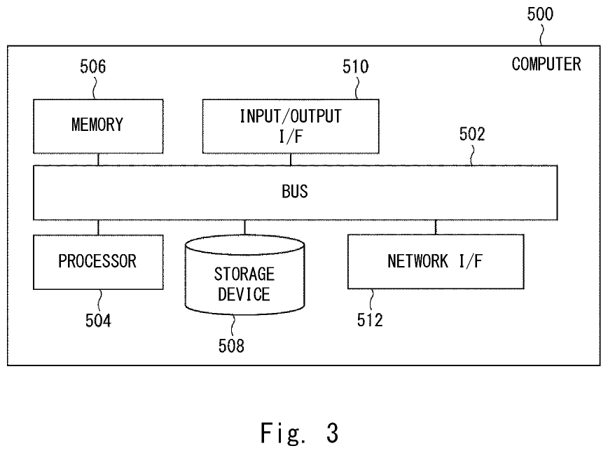

FIG. 3 is a block diagram showing an example of a hardware configuration of a computer 1000 for implementing the registration apparatus 2100. The computer 1000 is any computer. For example, the computer 1000 is a server machine or a stationary computer such as a PC (Personal Computer). Alternatively, for example, the computer 1000 is a portable computer such as a smartphone or a tablet terminal. The computer 1000 may be a dedicated computer designed to implement the registration apparatus 2100 or a general purpose computer.

For example, each function of the registration apparatus 2100 is implemented by the computer 1000 installing a predetermined application thereto. The above application is composed of a program for implementing functional components of the registration apparatus 2100. The method of acquiring the above program may be any method.

For example, the program can be acquired from a storage medium (such as a DVD disc or USB memory) in which the program is stored. In addition, the program can be acquired, for example, by downloading the program from a server apparatus managing a memory apparatus in which the program is stored.

The computer 1000 has a bus 1020, a processor 1040, a memory 1060, a storage device 1080, an input/output interface 1100, and a network interface 1120. The bus 1020 is a data transmission path for the processor 1040, the memory 1060, the storage device 1080, the input/output interface 1100, and the network interface 1120 to transmit and receive data to and from each other. However, the method of connecting the processors 1040 and the like to each other is not limited to bus connection.

The processor 1040 is one of various processors such as CPU (Central Processing Unit), GPU (Graphics Processing Unit), FPGA (Field-Programmable Gate Array), and DSP (Digital Signal Processor). The memory 1060 is a main memory apparatus implemented using RAM (Random Access Memory) or the like. The storage device 1080 is an auxiliary memory apparatus implemented using a hard disk, SSD (Solid State Drive), memory card, ROM (Read Only Memory), or the like.

The input/output interface 1100 is an interface for connecting the computer 1000 to an input/output device. For example, an input apparatus such as a keyboard and an output device such as a display apparatus are connected to the input/output interface 1100.

The network interface 1120 is for connecting the computer 1000 to a network. Note that this network may be a Local the area Network (LAN) or a Wide the area Network (WAN).

The storage device 1080 stores programs (programs for implementing the applications described above) for implementing respective functions of the registration apparatus 2100. The processor 1040 reads these programs into the memory 1060 and executes them to implement the respective functions of the registration apparatus 2100.

The registration apparatus 2100 may be implemented by one computer 1000 or by a plurality of the computers 1000. In the latter case, the configuration of each computer 1000 need not be identical and instead may be different from each other.

The reference apparatus 2200, like the registration apparatus 2100, can be implemented on any computer. For example, a hardware configuration of the reference apparatus 2200, like the hardware configuration of the registration apparatus 2100, is shown by FIG. 3. However, a program for implementing the function of each functional component of the reference apparatus 2200 is stored in the storage device of the computer implementing the reference apparatus 2200. The processor implementing the reference apparatus 2200 also implements the function of each functional component of the reference apparatus 2200 by reading the program from the storage device and executing it.

### Regarding Manufacturing Process Information

The manufacturing process information is a variety of information related to the manufacturing process of a product. For example, the manufacturing process information is procedure manual data that indicates a procedure manual defining the procedures for operations involved in manufacturing a product. Examples of the procedure manual include a manufacturing procedure manual, an inspection procedure manual, or an audit procedure manual. In this case, an item corresponding to a manufacturing process is expressed, for example, by a pair of a name of the item (e.g., “procedure manual”) and a name of the type of procedure (e.g., “manufacturing procedure” or “inspection procedure”). Also, if the procedure manual is created for each manufacturing step, the item may further include a name of the step.

For example, assume that manufacturing process information A1 is manufacturing procedure manual data for a manufacturing step P1 of a product I1. Here, it can be said that the manufacturing procedure of a product is the same regardless of the lot or individual product. Therefore, a digest value of the manufacturing process information A1 is associated with the product identification information of the product I1 and the item identification information indicating a combination of “procedure manual, manufacturing procedure, step P1”, and then put in the storage unit 2300.

In addition, for example, the manufacturing process information is data indicating (declaring, proving, or the like) that the manufacturing process of a product complies with the content of a specific item defined in a guideline for manufacturing the product. In this case, the item corresponding to the manufacturing process information is expressed by a combination of a name of the item (e.g., “guideline complied”), a name of a target guideline, and a name of a specific item in the guideline.

For example, assume that manufacturing process information A2 is information indicating a “manufacturing process for the product I1 complies with an item Y1 that is set forth in a guideline X1”. In this case, a digest value of the manufacturing process information A2 is put in the storage unit 2300 in association with the product identification information of the product I1 and the item identification information indicating a combination of “conformity to guideline, guideline X1, item Y1”.

In addition, for example, the manufacturing process information of the product is data indicating a record of various works carried out in the manufacturing process regarding the actual manufacturing of the product. The various records include, for example, manufacturing records, inspection records, or audit records.

When the manufacturing process information is data indicating a record of manufacturing, for example, the manufacturing process information indicates, for each manufacturing step, a record of manufacturing in that step. The item corresponding to this manufacturing process information is expressed by a pair of an item name by which a fact of being a record of the manufacturing process is indicated (e.g., “manufacturing record”) and the name of the corresponding manufacturing step.

Here, if the product I1 is manufactured in lots, a record of the manufacturing of this product can be made for each lot. Therefore, in this case, identification information that enables to identify a pair of a product and a lot is used as the product identification information. Suppose that a type number is used to identify a product and a lot number is used to identify a lot. In this case, a pair of “type number, lot number” is used as the product identification information. Note that the “number” here is not limited to a numerical string, and instead may be a string of any characters (numbers, alphabets, symbols, etc.).

For example, assume that manufacturing process information A3 indicates a manufacturing record of the manufacturing step P1 for a lot L1 of the product I1. In this case, the digest value of the manufacturing process information A3 is stored in the storage unit 2300 in association with the product identification information indicating a pair of “type number of product I1, lot number of lot L1” and the item identification information indicating a pair of “manufacturing record, step P1”.

Note that the recording of the manufacturing of the product may be performed for each individual product. For example, assume that manufacturing process information A4 indicates a manufacturing record of the manufacturing step P1 for an individual product B1 included in the lot L1 of the product I1. In this case, a digest value of the manufacturing process information A4 is stored in the storage unit 2300 in association with the product identification information represented by a combination of “type number of product I1, lot number of lot L1, individual number of individual product B1”, and the item identification information represented by a pair of “manufacturing record, step P1”. Here, the individual number is the identification information of the individual product. However, if the product I1 is not manufactured in lots, the lot number is not used.

Assume that the manufacturing process information is data indicating a record of an inspection. During the manufacturing process of a product, a plurality of types of inspections can be performed for each manufacturing step, such as acceptance inspection, in-step inspection, and completion inspection. Thus, for example, a combination of the item name “inspection record”, the name of the manufacturing step, and the name of the inspection is used for the item identification information that is associated with the manufacturing process information indicating an inspection record.

For example, assume that manufacturing process information A5 represents a record of an in-step inspection for the manufacturing step P1 for the lot L1 of the product I1. In this case, the digest value of manufacturing process information A5 is stored in the storage unit 2300 in association with the product identification information represented by a pair of “type number of product I1, lot number of lot L1” and the item identification information represented by a combination of “inspection record, step P1, in-step inspection”. Note that, as in the case of manufacturing records, when the inspection record is made for each individual product, the individual number is further added to the information stored in the storage unit 2300.

Assume that the manufacturing process information is data representing an audit record. An audit may include, for example, an audit verifying whether or not a product is manufactured in accordance with manufacturing procedure manuals or whether or not the manufacturing of a product is conducted in accordance with items in the guideline. In this case, the item corresponding to the manufacturing process information is represented by, for example, a pair of an item name by which a fact of being an audit record is indicated (e.g., “audit record”) and a name of an audit type. In addition, when the audit is conducted for each entire product, the type number of the product is used for the product identification information. When the audit is conducted on for each lot, the product identification information represented by a pair of “type number, lot number” is used. When the audit is conducted for each individual product, the product identification information represented by a combination of “type number, lot number, individual number” is used.

### Details on Functions of Registration Apparatus 2100

Hereinafter, the functions of the registration apparatus 2100 will be described in detail with reference to a flowchart showing a flow of processing executed by the registration apparatus 2100.

### <<Flow of Processing>>

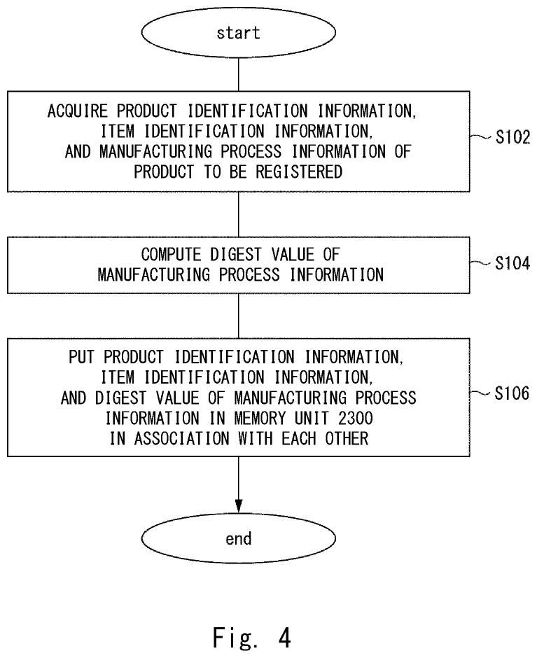

FIG. 4 is a flowchart showing an example of the flow of processing executed by the registration apparatus 2100 according to the first example embodiment. The acquiring unit 2120 acquires the product identification information, the item identification information, and the manufacturing process information of a product to be registered (S102). The saving unit 2140 computes the digest value of the manufacturing process information (S104). The saving unit 2140 puts the product identification information, the item identification information, and the digest value of the manufacturing process information in the storage unit 2300 in association with each other (S106).

### <<Information Acquisition: S102>>

The acquiring unit 2120 acquires the product identification information, the item identification information and the manufacturing process information of the product to be registered (S102). These pieces of information are acquired, for example, as a result of a user input made in arbitrary manner. For example, the acquiring unit 2120 provides the user with an interface for specifying these pieces of information, and acquires these pieces of information in response to an input operation to the interface.

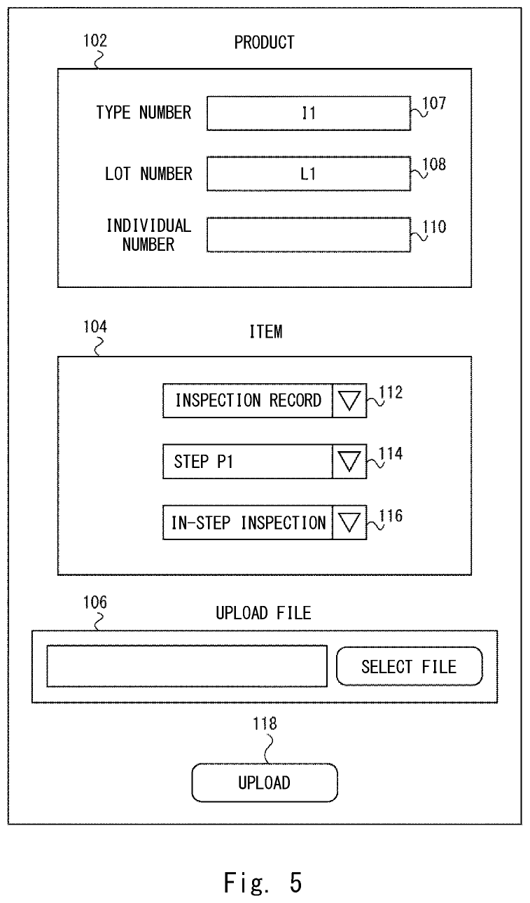

FIG. 5 shows an example of a screen for specifying information to be registered using the registration apparatus 2100. A specification screen 100 of FIG. 5 has areas 102, 104, and 106 as an interface for specifying information to be registered.

The area 102 is for specifying the product identification information. The area 102 has a sub-area 107 for inputting a type number, a sub-area 108 for inputting a lot number, and a sub-area 110 for inputting an individual number.

The area 104 is for specifying the item identification information. Here, the item identification information can be expressed in a hierarchical structure with different depths depending on the type of item, such as “manufacturing record, step P1” and “inspection record, step P1, in-step inspection” described above. Thus, for example, in the area 104, it is preferable to be able to specify the item identification information represented using such a plurality of levels.

For example, in FIG. 5, the area 104 has sub-areas 112, 114, and 116. The sub-area 112 is for specifying a value of the highest level of the item identification information. The sub-area 114 is for specifying a value of the second level of the item identification information. The sub-area 116 is for specifying a value of the third level of the item identification information. For example, assume that the item identification information represented by a combination of “inspection record, in-step inspection, step P1” is specified on the specification screen 100. In this case, “inspection record” is input in the sub-area 112, “in-step inspection” is input in the sub-area 114, and “step P1” is input in the sub-area 116.

It is preferable to define the types of items that can be specified and their hierarchical structures in advance. Therefore, for example, information indicating the hierarchical structure of items (hereinafter, referred to as item hierarchical information) is stored in advance in a storage unit (e.g., storage unit 2300) accessible from the registration apparatus 2100. The acquiring unit 2120 sets selectable items for the sub-areas 112, 114, and 116 using the item hierarchical information.

Specifically, the acquiring unit 2120 sets, as an item selectable in the sub-area 112, each item at the highest level in the hierarchical structure of the items. The acquiring unit 2120 also sets, as an item selectable in the sub-area 114, each item that is positioned directly under the item selected in the sub-area 112 in the hierarchical structure of the items. Furthermore, the acquiring unit 2120 sets, as an item selectable in the sub-area 116, each item that is positioned directly under the item selected in the sub-area 114 in the hierarchical structure of the items.

The types of items that can be specified and their hierarchical structures may differ from product to product. In this case, the item hierarchical information is stored for each product in a storage unit accessible from the registration apparatus 2100. For example, the item hierarchical information is stored in association with the type number of the corresponding product. In this case, the acquiring unit 2120 acquires the item hierarchical information associated with the type number specified in the sub-area 107 and sets selectable items.

The area 106 is for specifying the manufacturing process information. For example, the area 106 allows to specify a file stored in a storage unit accessible from the computer by which the specification screen 100 is displayed. For example, the file specified here is handled as data indicating the manufacturing process information.

The user presses a button 118 after making input in the areas 102, 104, and 106. As a result, the product identification information specified in the area 102, the item identification information specified in the area 104, and the manufacturing process information specified in the area 106 are transmitted to the registration apparatus 2100. The acquiring unit 2120 acquires the product identification information, the item identification information, and the manufacturing process information that are transmitted in this manner.

Here, the hierarchical structure of the items may be changeable during the operation of the management system 2000. This change can be achieved, for example, by changing the contents of the item hierarchical information.

The method of acquiring the manufacturing process information is not limited to the method of acquiring it through a user input. For example, the manufacturing process information may be provided automatically from another system managing the manufacturing process information. For example, any computer operated by each vendor (hereinafter, referred to as a collection apparatus) periodically collects the manufacturing process information of its products. The collection apparatus of each vendor acquires, for example, one or more combinations of “product identification information, item identification information, and manufacturing process information” that have not yet been provided to the management system 2000, from the production management system of the vendor's factory. The collection apparatus transmits each collected combination of “product identification information, item identification information, and manufacturing process information” to the registration apparatus 2100. The acquiring unit 2120 acquires the information provided in this manner. With this flow, the manufacturing process information managed by individual production management system of each vendor is shared by the management system 2000.

### <<Computation of Digest Value: S104>>

The saving unit 2140 computes the digest value of the manufacturing process information acquired by the acquiring unit 2120. Any algorithm (e.g., hash function) for computing the digest value can be used here. Instead of computing the digest value only for the manufacturing process information, the saving unit 2140 may compute the digest value of data that is obtained by attaching the product identification information, the item identification information, additional information to be described later, and the like to the manufacturing process information.

A time stamp may be attached to the digest value computed here. Date and time information obtained from any device may be used for the time stamp. The device for obtaining the date and time information may be installed inside the registration apparatus 2100 (such as a clock installed in the computer 1000 implementing the registration apparatus 2100) or outside the registration apparatus 2100 (such as a GPS (Global Positioning System) satellite).

For example, the saving unit 2140 generates data (hereinafter, referred to as time-stamped manufacturing process information) by attaching the time stamp to the digest value of the manufacturing process information, and computes the digest value of the time-stamped manufacturing process information. This digest value is then used as the digest value to be put in the storage unit 2300. That is, the digest value of the time-stamped manufacturing process information is used as the “computed digest value of the manufacturing process information” in the explanation to be described later.

In addition, for example, the saving unit 2140 may generate data (hereinafter, referred to as time-stamped digest value) by attaching a time stamp to the digest value of manufacturing process information, and computes a digest value of this time-stamped digest value. In this case, both the time-stamped digest value and the digest value of the time-stamped digest value are put in the storage unit 2300.

### <<Registration of Manufacturing Process Information: S106>>

The saving unit 2140 puts the computed digest value of the manufacturing process information in the storage unit 2300 in association with the product identification information and the item identification information acquired by the acquiring unit 2120 (S106). As described above, the information indicating the association of “the product identification information, the item identification information, and the digest value of the manufacturing process information” stored in the storage unit 2300 is referred to as registration information.

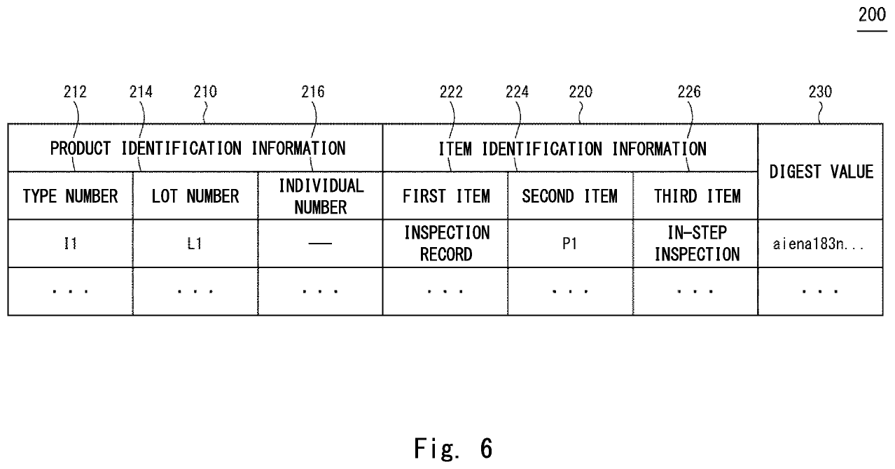

FIG. 6 shows an example of the registration information in a table format. Registration information 200 has three columns: a product identification information 210, an item identification information 220, and a digest value 230. Each record of the registration information 200 indicates an association between the product identification information, the item identification information, and the manufacturing process information.

The product identification information 210 includes three elements: type number 212, lot number 214, and individual number 216. It is noted that, if the product identification information acquired by the acquiring unit 2120 does not include a lot number or an individual number, no data needs to be stored in the lot number 214 or the individual number 216.

The item identification information 220 includes three elements: a first item 222, a second item 224, and a third item 226. The first item 222 indicates identification information (name of the item, identification number associated with the name, etc.) of the item at the highest level in the hierarchical structure of the items. The second item 224 indicates identification information of the item at the second level in the hierarchical structure of the items. The third item 226 indicates identification information of the item at the third level in the hierarchical structure of the items. However, if the item identification information acquired by the acquiring unit 2120 does not include the identification information of the second or third level, no data needs to be stored in the second item 224 or the third item 226.

Here, the manufacturing process information itself may be further stored in the storage unit 2300. In this case, the manufacturing process information is further included in the registration information. However, it is preferable that the registration of the manufacturing process information be non-mandatory.

Furthermore, the registration information may further include other information (hereinafter, referred to as additional information) in addition to the product identification information, the item identification information, the digest value of the manufacturing process information, and the manufacturing process information itself. The additional information is acquired by the acquiring unit 2120 together with the manufacturing process information.

For example, the additional information includes date and time information related to the manufacturing process information. The date and time information is information that is associated with the manufacturing process information in advance. For example, the date and time information indicates date and time when the manufacturing process information is created. In addition, for example, if the manufacturing process information indicates a record of some work (manufacture, inspection, or audit, etc.), the date and time information may indicate the date and time of that work. Note that the aforementioned time stamp is different from the date and time information included in the additional information in that it represents the date and time when the processing is performed by the registration apparatus 2100.

In addition, for example, the additional information includes person information related to the manufacturing process information. The person information indicates, for example, information (name, identification number, etc.) about a creator of the manufacturing process information. Furthermore, for example, if the manufacturing process information indicates a record of some work, the person information may indicate information (name, identification number, etc.) about a person performing that work. In addition to or in place of information such as a name and an identification number, a digital signature may be used.

In addition, for example, the additional information may include information about resources used for the work (e.g., parts, production lines, or work equipment, etc.) and information such as a product of the work.

### Details on Functions of Reference Apparatus 2200>

Next, the functions of the reference apparatus 2200 will be described in detail with reference to a flowchart showing the flow of processing executed by the reference apparatus 2200.

### <<Flow of Processing>>

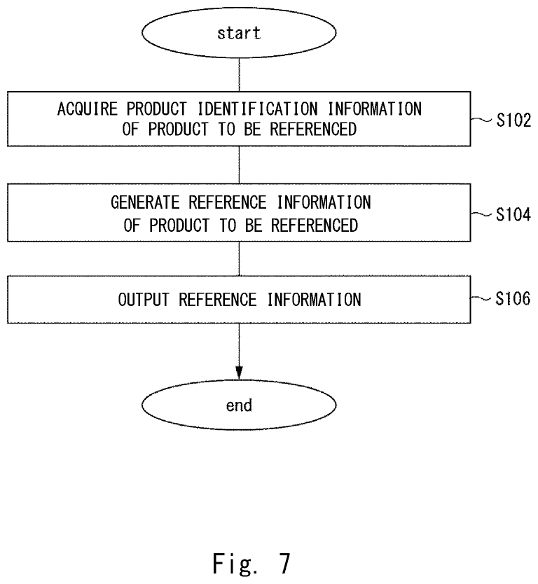

FIG. 7 is a flowchart showing an example of the flow of processing executed by the reference apparatus 2200 according to the first example embodiment. The acquiring unit 2220 acquires the product identification information of the product to be referenced (S202). For one or more pieces of the item identification information, the outputting unit 2240 generates the reference information that enables to know whether or not the acquired product identification information and the digest value of the manufacturing process information associated with the item identification information are stored in the storage unit 2300 (S204). The outputting unit 2240 outputs the generated reference information (S206).

### <<Information Acquisition: S202>>

The acquiring unit 2220 acquires the product identification information of the product to be referenced (S202). This acquisition is performed, for example, as a result of a user input performed in arbitrary manner. For example, the acquiring unit 2220 provides the user with an interface for specifying the product identification information. For example, an interface similar to the area 102 included in the specification screen 100 of FIG. 5 may be used for this interface. The acquiring unit 2220 acquires the product identification information of the product to be referenced in response to an input operation to such an interface.

The acquiring unit 2220 may further acquire the item identification information of the item to be referenced. In this case, for example, the acquiring unit 2220 provides the user with an interface for specifying the item identification information. For example, an interface similar to the area 104 included in the specification screen 100 of FIG. 5 may be used. The acquiring unit 2220 acquires the item identification information of the item to be referenced in response to an input operation to such an interface.

By specifying an item at a higher level in the hierarchical structure of the items, items under the specified item may be collectively specified as items to be referenced. For example, as shown as an example in FIG. 5, assume that the hierarchical structure of the items includes three levels. In this case, for example, by specifying the item at the highest level, all the items of the second and third levels under the specified item can be specified. For example, by specifying an “inspection record” at the highest level, all combinations of inspection types and step types can be specified. That is, the reference information of all inspection records can be obtained for the product to be referenced.

Similarly, if the upper level and the second level are specified, all the items at the third level under the specified item at the second level can be designated. For example, by specifying “item at the first level=inspection record, item at the second level=in-step inspection”, all steps are specified. That is, the reference information of the in-step inspection records can be obtained for all steps for the product to be referenced.

### <<Generation of Reference Information: S204>>

For one or more pieces of the item identification information, the outputting unit 2240 generates the reference information that enables to know whether or not the digest value of the manufacturing process information associated with the item identification information and the product identification information of the product to be referenced is stored in the storage unit 2300.

For example, for each of all pieces of the item identification information, the outputting unit 2240 determines whether or not the digest value of the manufacturing process information is stored in the storage unit 2300 in association with the item identification information and the product identification information of the product to be referenced. In this way, for each of all items, it is possible to know whether or not the manufacturing process information of the item is present.

Specifically, the outputting unit 2240 accesses the storage unit 2300 and determines, for each item, whether or not the registration information indicating a pair of “product identification information of the product to be referenced, the item identification information of the item” is stored in the storage unit 2300. When the registration information indicating the pair is stored in the storage unit 2300, the digest value of the manufacturing process information corresponding to the pair is stored in the storage unit 2300. On the other hand, when the registration information indicating the pair is not stored in the storage unit 2300, the digest value of the manufacturing process information corresponding to the pair is not stored in the storage unit 2300. The outputting unit 2240 generates the reference information indicating a result of the above determination.

Here, the types of items that can be specified may vary from product to product. Therefore, the aforementioned item hierarchical information is prepared for each product and stored in a storage unit (e.g., storage unit 2300) accessible from the reference apparatus 2200. The outputting unit 2240 acquires the item hierarchical information corresponding to the product to be referenced using the product identification information of the product to be referenced. Next, the outputting unit 2240 generates the reference information for each of all pieces of the item identification information that are determined using the item hierarchical information.

In addition, for example, the management system 2000 may accept specification of an item to be referenced in addition to a product to be referenced. In this way, it is possible to know whether or not the manufacturing process information of a specific item is present for the product to be referenced. The method for specifying the item to be referenced is as described above.

In this case, by determining whether or not the registration information indicating the pair of “product identification information of the product to be referenced, item identification information of the item to be referenced” is stored in the storage unit 2300, the outputting unit 2240 determines whether or not the digest value of the manufacturing process information associated with this pair is stored in the storage unit 2300. The outputting unit 2240 then generates the reference information indicating a result of the determination.

As described above, by specifying a higher level in the hierarchical structure of items, items under that level may be collectively specified. In this case, the outputting unit 2240 determines whether or not the digest value of the manufacturing process information associated with the “product identification information of the product to be referenced, item identification information of the item” is stored in the storage unit 2300 for each of the plurality of items specified in this manner.

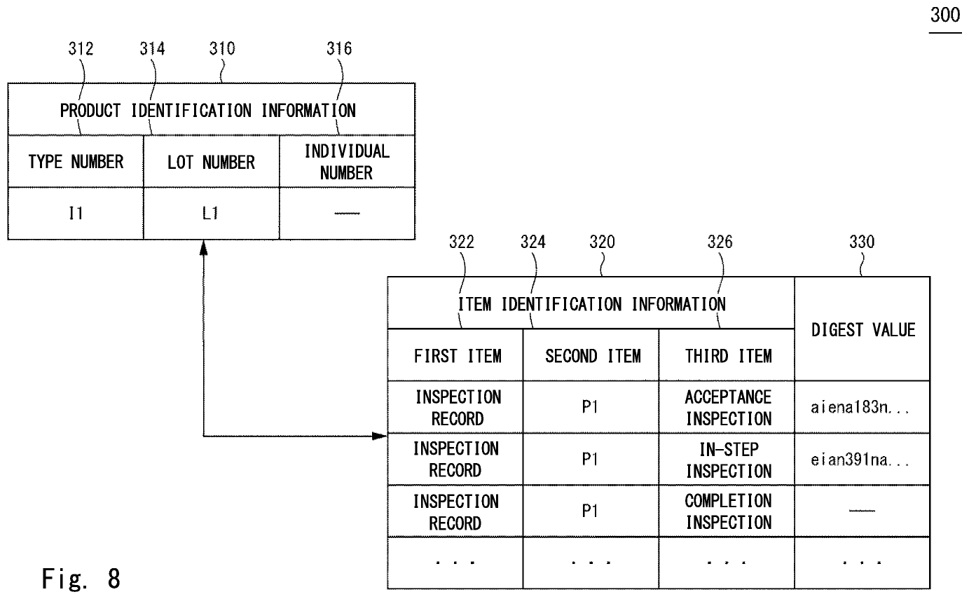

FIG. 8 shows an example of the reference information. Reference information 300 shown by FIG. 8 is information that associates a table showing the digest value of the manufacturing process information for each item with the product identification information of the product to be referenced. The product identification information of the product to be referenced is indicated by product identification information 310. The item identification information of each item to be referenced is indicated by item identification information 320. A digest value of the manufacturing process information of each item is indicated by a digest value 330.

Here, for pairs of “product identification information, item identification information” for which the corresponding digest value of manufacturing process information is not stored in the storage unit 2300, the corresponding digest value 330 indicates no data. Using the reference information configured in this way, it is possible to know whether or not the corresponding digest value of the manufacturing process information is stored in the storage unit 2300 based on whether or not the digest value 330 indicates data.

For example, in FIG. 8, data is indicated by the digest value 330 that corresponds to the product identification information represented by a pair of “type number I1, lot number L1” and the item identification information represented by a combination of “inspection record, step P1, acceptance inspection”. Therefore, it can be understood that the manufacturing process information indicating the record of the acceptance inspection in the step P1 is present for the lot L1 of the product I1. The same is applied to the in-step inspection.

On the other hand, no data is indicated by the digest value 330 that corresponds to the item identification information represented by the combination of “inspection record, step P1, completion inspection”. Therefore, it can be understood that there is no manufacturing process information indicating a record of a completion inspection in the step P1 for the lot L1 of the product I1.

### <<Output of Reference Information: S206>>

The outputting unit 2240 outputs the generated reference information (S206). For example, the reference information is transmitted by any method to a computer (such as a PC or mobile terminal) used by a user of the reference apparatus 2200. For example, the user of the reference apparatus 2200 transmits a request to the reference apparatus 2200 requesting the transmission of the reference information. The request includes the product identification information of the product to be referenced. If an item to be referenced is also specified, the item identification information of that item is also included in the request. The reference apparatus 2200 transmits the reference information as a response to the request.

The method by which the outputting unit 2240 outputs the reference information is not limited to the method of transmitting to another apparatus, and instead may be any method. For example, the outputting unit 2240 may display the reference information on a display apparatus accessible from the reference apparatus 2200, or may put the reference information in a storage unit accessible from the reference apparatus 2200.

### Specific Example of Situation in Which Management System 2000 is Used

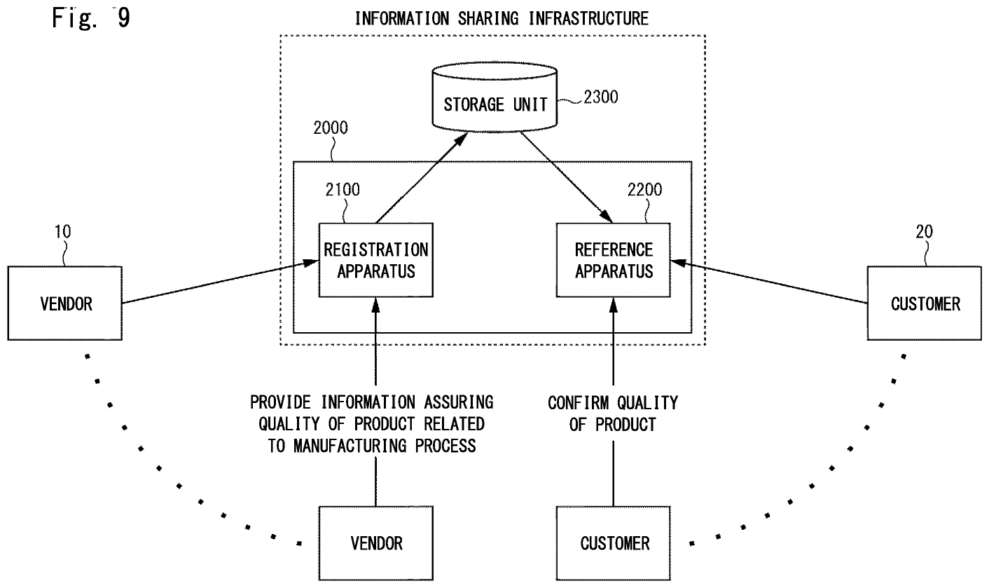

An example of a more specific use case of the management system 2000 is shown here. FIG. 9 shows a use case of the management system 2000. In this example, the management system 2000 is used as an information sharing infrastructure among a plurality of vendors 10 in a cooperative relationship to share information to ensure product quality (such as safety and reliability). Customers 20 who are considering using or already using products manufactured by these vendors 10 can check the quality of their products by using the information sharing infrastructure.

For example, assume that the customer 20 is a company providing systems to other companies. In this case, companies to which the systems are provided may provide procurement standards to be met by the products (equipment, etc.) employed in the systems. In this case, the customer 20 needs to determine whether or not each product meets the procurement standards when selecting the products to be used in the systems. Therefore, the customer 20 determines whether or not each product meets the procurement standards by checking the quality of each product using the management system 2000.

For example, confirmation of quality of a product can be made by confirming that various types of manufacturing process information are present (i.e., confirming that digest values of manufacturing process information are stored in the storage unit 2300). For example, if the manufacturing process information indicating an inspection record is present for each step in manufacturing a product, it is possible to know that the product is correctly inspected at the time of manufacture.

The vendor 10 then registers the digest values of various manufacturing process information of its products in the management system 2000. For example, the registration apparatus 2100 functions as a server providing a website accessible from a computer used by the vendor 10. The website serves as an interface for registering the digest values of the manufacturing process information. Workers of the vendor 10 use the website to perform registration works. For example, the website provides an interface such as the specification screen 100 in FIG. 5.

Here, it is preferable to provide a mechanism in the management system 2000 to prevent tampering of data stored in the storage unit 2300. Therefore, it is preferable to configure the storage unit 2300, for example, so that tampering of stored data is difficult. One of the methods for configuring the storage unit 2300 is to implement the storage unit 2300, for example, with a storage using blockchain technology. In other words, the storage unit 2300 is configured so that data is stored in blockchain.

It is preferable to use a computer owned and operated by each vendor 10 for a node constituting the blockchain. By doing so, the data stored in the storage unit 2300 is managed by the plurality of vendors 10, and resistance properties against data tampering can be enhanced.

The customer 20 uses the reference apparatus 2200 to browse desired information related to the quality of the product. For example, the reference apparatus 2200 functions as a server providing a website accessible from a computer used by the customer 20. The website serves as an interface for browsing information stored in the storage unit 2300. The customer 20 browses the desired information by accessing the website using any computer. The information browsed by the customer 20 is, for example, the reference information described above.

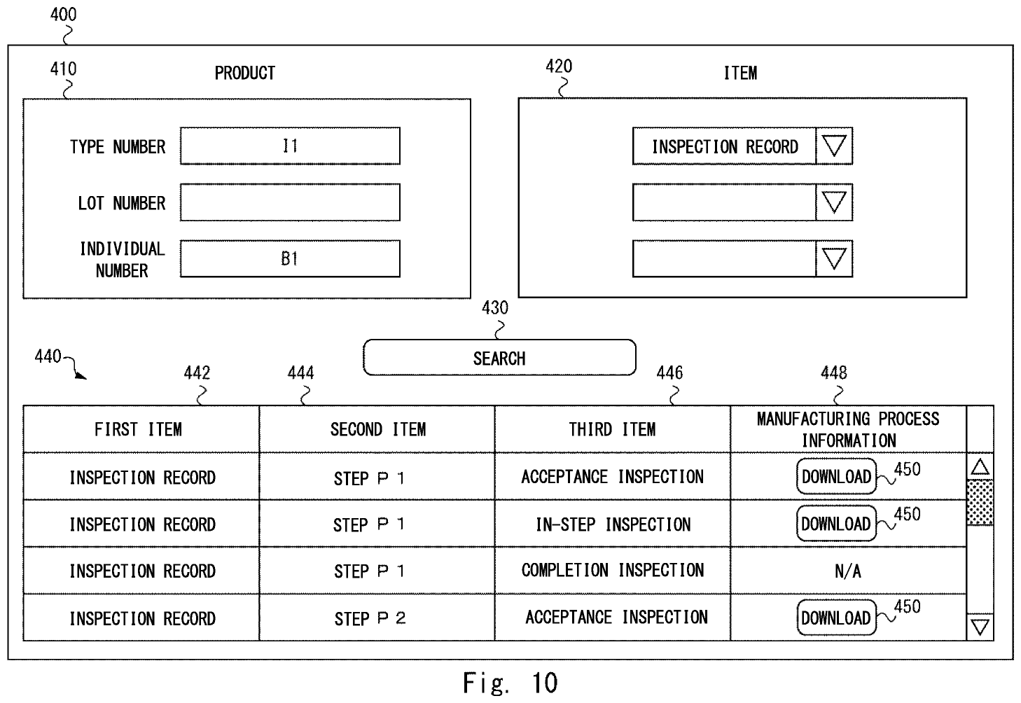

As specific examples of the method for browsing the reference information, examples of some of the screens of the website provided by the reference apparatus 2200 are shown below. FIG. 10 is a first diagram showing an example of the screen provided by the reference apparatus 2200. In a reference screen 400 of FIG. 10, the reference information of any product and item can be obtained. In other words, it is possible to confirm whether or not the corresponding manufacturing process information is present for any combination of a product and an item.

The reference screen 400 has an area 410 for specifying the product to be referenced, an area 420 for specifying the item to be referenced, a search button 430 for requesting acquisition of reference information, and an area 440 for displaying the reference information.

The customer 20 specifies the product and the item to be referenced by making an input to the areas 410 and 420. The customer 20 then presses the search button 430. As a result, a request including the identification information of the product to be referenced and the item identification information of the item to be referenced is transmitted to the reference apparatus 2200. The acquiring unit 2220 acquires the information transmitted in this manner. The outputting unit 2240 generates the reference information using the acquired information and displays the generated reference information in the area 440.

The reference information displayed in the area 440 includes four elements: a first item 442, a second item 444, a third item 446, and manufacturing process information 448. For each item identified by a combination of the first item 442, the second item 444, and the third item 446, the reference information includes a download button 450 or a string “n/a” in the manufacturing process information 448.

For the item for which the download button 450 is displayed in the corresponding manufacturing process information 448, the digest value of the corresponding manufacturing process information is stored in the storage unit 2300. The customer 20 can download the digest value of the manufacturing process information by pressing the download button 450. On the other hand, for the item for which the string “n/a” is displayed in the corresponding manufacturing process information 448, the digest value of the corresponding manufacturing process information is not stored in the storage unit 2300.

Here, the algorithm for obtaining the manufacturing process information itself from the digest value of the manufacturing process information may be disclosed to the customer 20. In this case, the customer 20 can obtain the manufacturing process information from the downloaded digest value of the manufacturing process information.

The authenticity of the manufacturing process information (a fact that the manufacturing process information has not been tampered with) may be confirmed by including the aforementioned time stamp in the digest value. Specifically, the customer 20 obtains the time stamp by converting the downloaded digest value into original data. For example, assume that the data downloaded by the customer 20 is the digest value of the time-stamped manufacturing process information. In this case, the time-stamped manufacturing process information is obtained from the digest value. The customer 20 can confirm the authenticity of the manufacturing process information by determining whether or not the date and time indicated by the time stamp is valid.

For example, the time stamp attached to the manufacturing process information for a certain step should indicate the date and time prior to the working date and time of the next step. Therefore, if the time stamp attached to the manufacturing process information for a certain step indicates the date and time on or after the work date and time of the next step, the manufacturing process information is likely to have been tampered with. In this manner, for example, the customer 20 confirms the authenticity of the manufacturing process information by comparing the time stamp attached to the manufacturing process information with the work date and time of the step related to the manufacturing process information.

The information that can be acquired by pressing the download button 450 is not limited to the digest value of the manufacturing process information. For example, the manufacturing process information itself may be made available for download by pressing the download button 450. In this case, the registration apparatus 2100 is configured to also store the manufacturing process information in the storage unit 2300. However, as described above, it is preferable that the registration of the manufacturing process information itself be not mandatory. Therefore, the storage unit 2300 can contain a mixture of the registration information including the manufacturing process information itself and the registration information not including the manufacturing process information itself.

In order to obtain the manufacturing process information, it may be configured to require permission from the individual vendor 10. For example, it may be configured that the manufacturing process information and its digest value cannot be obtained directly from the storage unit 2300, and instead each vendor 10 may retain the manufacturing process information on its own server or the like. In this case, the customer 20 who wants to obtain the manufacturing process information individually requests the vendor 10 to provide the manufacturing process information. For example, by pressing the aforementioned download button 450, a request form requesting the vendor 10 to provide the manufacturing process information may be opened. In this way, the customer 20 can easily request the vendor 10 to disclose the manufacturing process information. Alternatively, for example, it may be configured that while the digest value of the manufacturing process information can be obtained from the storage unit 2300, the algorithm for obtaining the manufacturing process information itself from the digest value may be undisclosed. Also in this case, the customer 20 acquires the manufacturing process information by making a request to the vendor 10.

Here, the management system 2000 may determine whether or not the procurement standards required by the customer 20 are satisfied based on the manufacturing process information, and a result of the determination may be provided to the customer 20. For example, the customer 20 provides standard information indicating the procurement standards to the reference apparatus 2200 together with the product identification information of the product to be referenced. The reference apparatus 2200 acquires the manufacturing process information from the storage unit 2300 and determines whether or not the content of the manufacturing process information satisfies the procurement standards indicated by the standard information. The reference apparatus 2200 then outputs information indicating a result of the determination.

The standard information may be stored in advance in a storage device that can be referenced from the reference apparatus 2200. In this case, the customer 20 provides the reference apparatus 2200 with its own identification information together with the product identification information of the product to be referenced, and so on. The reference apparatus 2200 acquires the standard information corresponding to the acquired identification information of the customer 20, and uses the standard information to determine whether or not the manufacturing process information satisfies the procurement standards.

Note that determination processing for the procurement standards may be performed by the storage unit 2300 instead of the reference apparatus 2200. For example, when the storage unit 2300 is implemented in a blockchain, the processing for determining whether or not the manufacturing process information satisfies the procurement standards is implemented as a program (smart contract) running on the blockchain. To determine whether or not the procurement standards are satisfied on the blockchain can make it difficult to forge the determination result.

In this way, even when the result of the determination as to whether or not the procurement standards are satisfied is output by the reference apparatus 2200, the various methods described above can be employed as the method for referencing the manufacturing process information itself. Specifically, the methods include 1) a method of acquiring the digest value of the manufacturing process information from the storage unit 2300 and obtaining the original manufacturing process information from the digest value, 2) a method of acquiring the manufacturing process information itself from the storage unit 2300, and 3) a method of acquiring the manufacturing process information retained by each vendor 10 with the permission of the vendor 10.

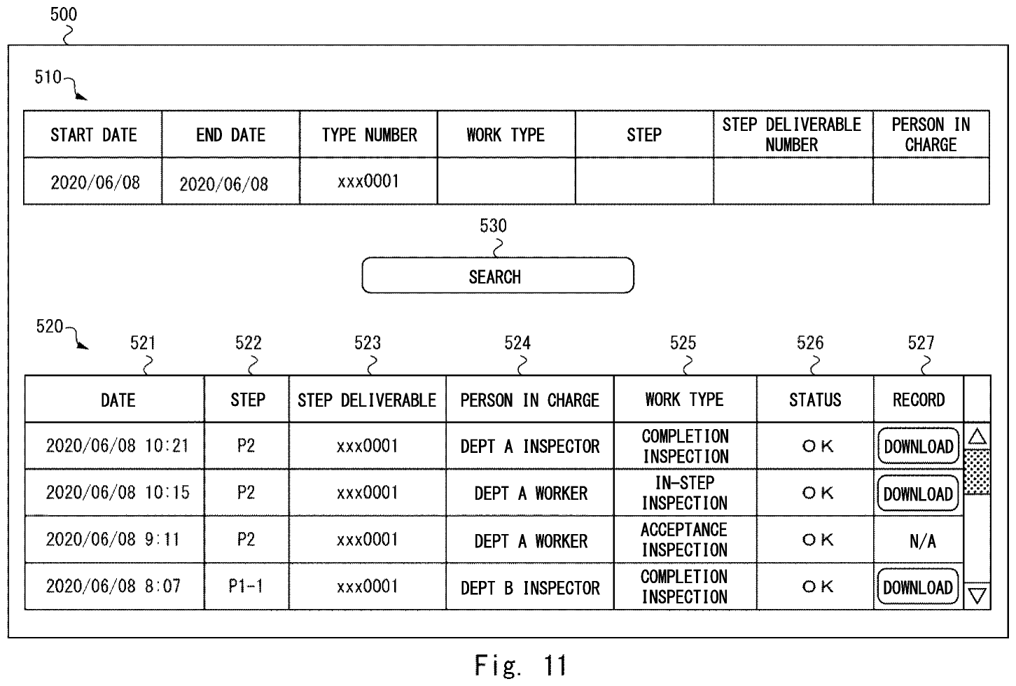

A screen for browsing the reference information may be provided for each type of information desired to be acquired. As one example, a screen for confirming that each task in the manufacturing process has been successfully completed is shown as an example. FIG. 11 is a second diagram showing an example of the screen provided by the reference apparatus 2200. A screen 500 in FIG. 11 has an area 510 for specifying search conditions, a search button 530, and an area 520 for displaying the reference information.

In the area 510, each of start and end dates of a date range, a type number of a product, a step, a work type, a step deliverable number, and a person in charge can be specified. When the search button 530 is pressed, the reference apparatus 2200 searches for the registration information under the conditions specified in the area 510, and generates the reference information indicating a result of the search. The reference information displayed in the area 520 includes the following elements: date 521, step 522, step deliverable 523, person in charge 524, work type 525, status 526, and record 527.

In the reference information displayed in the area 520, the item is specified by a combination of a value of the step 522 and a value of the work type 525. In the reference information displayed in the area 520, whether or not the digest value of the manufacturing process information is stored in the storage unit 2300 can be known by the data shown by the record 527. Specifically, a download button is displayed in the record 527 for the item for which the digest value of the corresponding manufacturing process information is stored in the storage unit 2300. On the other hand, for the item for which the digest value of the corresponding manufacturing process information is not stored in the storage unit 2300, “n/a” is displayed in the record 527.

By browsing the reference information displayed in the area 520, the customer 20 can know an overview of the work for each work matching the search condition. Also, by viewing the status 526, it is possible to know whether or not the work has been completed normally. Furthermore, by viewing the record 527, it is possible to know whether or not the manufacturing process information indicating a record of each work is stored in the storage unit 2300.

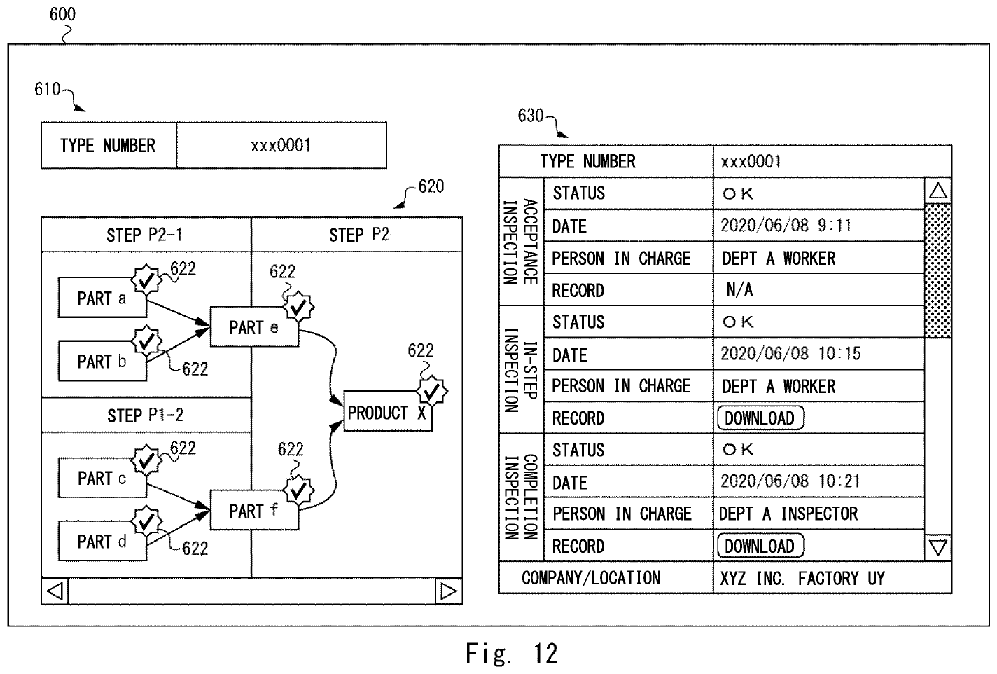

As another example of a screen prepared for each type of information the customer 20 wants to know, an example of a screen for checking configuration information and work history of a product is shown. FIG. 12 is a third diagram showing an example of the screen provided by the reference apparatus 2200. A screen 600 in FIG. 12 has areas 610, 620, and 630. The area 610 is for specifying a product to be referenced. In FIG. 12, a product X is specified.

The area 620 is an area that displays the configuration information of the product to be referenced. More specifically, the area 620 shows a step of manufacturing the product in time series. For each step, the area 620 shows a parts configuration of the product by connecting the parts that are used and manufactured parts (deliverables) with arrows. For example, in the example of FIG. 12, in a step P1-1, a part e is manufactured from parts a and b. In a step P1-2, a part f is manufactured from parts c and d. In a step P2, the product X is manufactured from parts e and f. By referring to this information, it is easy to understand what parts the product is made of and in what manufacturing step each part is obtained or manufactured.

In addition, the area 620 has a mark 622 for each part or product. The user can select the corresponding part or product by pressing the mark 622.

The work history for the part or product selected by pressing the mark 622 is displayed in the area 630. For example, in FIG. 12, the mark 622 of the product X is pressed. Therefore, the work history of the product X is displayed in the area 630. Here, the work history displayed in the area 630 serves as the reference information.

Specifically, the work history displayed in the area 630 displays, for the selected part or product, records of manufacturing works and inspections performed in the process of manufacturing the product (e.g., step P2 in FIG. 12). Here, whether or not a digest value of the manufacturing process information is present can be known by whether the download button or the string “n/a” is displayed in the “record” part.

By using the screen 600, the customer 20 can know the configuration of the product to be referenced along with the time series of the manufacturing step. In addition, the customer 20 can know the history of the work performed on the product itself or its parts to be referenced. By viewing the history of the work, it is possible to know whether or not the manufacturing process information indicating the record of each work is stored in the storage unit 2300.

Although the present disclosure has been described above with reference to the example embodiment, the present disclosure is not limited to the above example embodiment. Various modifications can be made to the configuration and details of the present disclosure that can be understood by those skilled in the art within the scope of the present disclosure.

In the above examples, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The whole or part of the example embodiments disclosed above can be described as, but not limited to, the following supplementary notes.

### (Supplementary Note 1)

A registration apparatus comprising:

an acquiring unit configured to acquire identification information of a product to be registered, identification information of an item related to a manufacturing process, and manufacturing process information related to the item among the manufacturing process information related to the manufacturing process of the product; and

a saving unit configured to compute a digest value of the acquired manufacturing process information, and put the computed digest value in a storage unit in association with the acquired identification information of the product and the acquired identification information of the item.

### (Supplementary Note 2)

The registration apparatus according to Supplementary note 1,

wherein the manufacturing process information is data of a procedure manual that defines a procedure of a work related to manufacturing of the product, data indicating that the manufacturing process of the product complies with a guideline, or data indicating a record of a work performed in the manufacturing process of the product.

### (Supplementary Note 3)

A reference apparatus that is communicably connected to a storage unit, the storage unit storing, in association with identification information of a product and identification information of an item related to a manufacturing process, a digest value of the manufacturing process information related to the item among the manufacturing process information related to the manufacturing process of the product,

wherein the reference apparatus comprising:

an acquiring unit configured to acquire the identification information of the product to be referenced; and

an outputting unit configured to output reference information by which it can determine, for one or more of the items, whether or not the digest value of the manufacturing process information is stored in the storage unit in association with the identification information of the item and the identification information of the product to be referenced.

### (Supplementary Note 4)

The reference apparatus according to Supplementary note 3,

wherein the manufacturing process information is data of a procedure manual that defines a procedure of a work related to manufacturing of the product, data indicating that the manufacturing process of the product complies with a guideline, or data indicating a record of a work performed in the manufacturing process of the product.

### (Supplementary Note 5)

The reference apparatus according to Supplementary note 3 or 4,

wherein the outputting unit determines the identification information of each of a plurality of the items that can be associated with the identification information of the product to be referenced, and outputs the reference information for each of the determined items.

### (Supplementary Note 6)

The reference apparatus according to Supplementary note 3 or 4,

wherein the acquiring unit further acquires the identification information of the item to be referenced, and

wherein the outputting unit outputs the reference information for the acquired identification information of the item to be referenced.

### (Supplementary Note 7)

A registration method executed by a computer comprising:

an acquiring step of acquiring identification information of a product to be registered, identification information of an item related to a manufacturing process, and manufacturing process information related to the item among the manufacturing process information related to the manufacturing process of the product; and

a saving step of computing a digest value of the acquired manufacturing process information and putting the computed digest value in a storage unit in association with the acquired identification information of the product and the acquired identification information of the item.

### (Supplementary Note 8)

The registration method according to Supplementary note 7,

wherein the manufacturing process information is data of a procedure manual that defines a procedure of a work related to manufacturing of the product, data indicating that the manufacturing process of the product complies with a guideline, or data indicating a record of a work performed in the manufacturing process of the product.

### (Supplementary Note 9)

A reference method executed by a computer, which is communicably connected to a storage unit, the storage unit storing, in association with identification information of a product and identification information of an item related to a manufacturing process, a digest value of the manufacturing process information related to the item among the manufacturing process information related to the manufacturing process of the product,

wherein the reference method comprising:

an acquiring step of acquiring the identification information of the product to be referenced; and

an outputting step of outputting reference information by which it can determine, for one or more of the items, whether or not the digest value of the manufacturing process information is stored in the storage unit in association with the identification information of the item and the identification information of the product to be referenced.

### (Supplementary Note 10)

The reference method according to Supplementary note 9,

wherein the manufacturing process information is data of a procedure manual that defines a procedure of a work related to manufacturing of the product, data indicating that the manufacturing process of the product complies with a guideline, or data indicating a record of a work performed in the manufacturing process of the product.

### (Supplementary Note 11)

The reference method according to Supplementary note 9 or 10,

wherein the outputting step includes determining the identification information of each of a plurality of the items that can be associated with the identification information of the product to be referenced, and outputting the reference information for each of the determined items.

### (Supplementary Note 12)

The reference method according to Supplementary note 9 or 10,

wherein the acquiring step includes further acquiring the identification information of the item to be referenced, and wherein the outputting step includes outputting the reference information for the acquired identification information of the item to be referenced.

### (Supplementary Note 13)

A computer readable medium storing a program for causing a computer to execute:

an acquiring step of acquiring identification information of a product to be registered, identification information of an item related to a manufacturing process, and manufacturing process information related to the item among the manufacturing process information related to the manufacturing process of the product; and

a saving step of computing a digest value of the acquired manufacturing process information and putting the computed digest value in a storage unit in association with the acquired identification information of the product and the acquired identification information of the item.

### (Supplementary Note 14)

The computer readable medium according to Supplementary note 13,

wherein the manufacturing process information is data of a procedure manual that defines a procedure of a work related to manufacturing of the product, data indicating that the manufacturing process of the product complies with a guideline, or data indicating a record of a work performed in the manufacturing process of the product.

### (Supplementary Note 15)

A computer readable medium storing a program executed by a computer, which is communicably connected to a storage unit, the storage unit storing, in association with identification information of a product and identification information of an item related to a manufacturing process, a digest value of the manufacturing process information related to the item among the manufacturing process information related to the manufacturing process of the product,

wherein the program causing the computer to execute:

an acquiring step of acquiring the identification information of the product to be referenced; and

an outputting step of outputting reference information by which it can determine, for one or more of the items, whether or not the digest value of the manufacturing process information is stored in the storage unit in association with the identification information of the item and the identification information of the product to be referenced.

### (Supplementary Note 16)

The computer readable medium according to Supplementary note 15,

wherein the manufacturing process information is data of a procedure manual that defines a procedure of a work related to manufacturing of the product, data indicating that the manufacturing process of the product complies with a guideline, or data indicating a record of a work performed in the manufacturing process of the product.

### (Supplementary Note 17)

The computer readable medium according to Supplementary note 15 or 16,

wherein the outputting step includes determining the identification information of each of a plurality of the items that can be associated with the identification information of the product to be referenced, and outputting the reference information for each of the determined items.

### (Supplementary Note 18)

The computer readable medium according to Supplementary note 15 or 16,

wherein the acquiring step includes further acquiring the identification information of the item to be referenced, and

wherein the outputting step includes outputting the reference information for the acquired identification information of the item to be referenced.

### (Supplementary Note 19)

A management system comprising a registration apparatus and a reference apparatus,

wherein the registration apparatus comprises:
an acquiring unit configured to acquire identification information of a product to be registered, identification information of an item related to a manufacturing process, and manufacturing process information related to the item among the manufacturing process information related to the manufacturing process of the product; and
a saving unit configured to compute a digest value of the acquired manufacturing process information, and put the computed digest value in a storage unit in association with the acquired identification information of the product and the acquired identification information of the item, and

the reference apparatus comprises:
an acquiring unit configured to acquire the identification information of the product to be referenced; and
an outputting unit configured to output reference information by which it can determine, for one or more of the items, whether or not the digest value of the manufacturing process information is stored in the storage unit in association with the identification information of the item and the identification information of the product to be referenced.

### (Supplementary Note 20)

A management method executed by a management system comprising a registration apparatus and a reference apparatus, the management method comprising:

executing, by the registration apparatus,
an acquiring step of acquiring identification information of a product to be registered, identification information of an item related to a manufacturing process, and manufacturing process information related to the item among the manufacturing process information related to the manufacturing process of the product; and
a saving step of computing a digest value of the acquired manufacturing process information and putting the computed digest value in a storage unit in association with the acquired identification information of the product and the acquired identification information of the item, and

executing, by the reference apparatus,
an acquiring step of acquiring the identification information of the product to be referenced; and
an outputting step of outputting reference information by which it can determine, for one or more of the items, whether or not the digest value of the manufacturing process information is stored in the storage unit in association with the identification information of the item and the identification information of the product to be referenced.

### REFERENCE SIGNS LIST

### 10 VENDOR

### 20 CUSTOMER

### 100 SPECIFICATION SCREEN

### 102 AREA

### 104 AREA

### 106 AREA

### 108 SUB-AREA

### 110 SUB-AREA

### 112 SUB-AREA

### 114 SUB-AREA

### 116 SUB-AREA

### 118 BUTTON

### 200 REGISTRATION INFORMATION

### 210 PRODUCT IDENTIFICATION INFORMATION

### 212 TYPE NUMBER

### 214 LOT NUMBER

### 216 INDIVIDUAL NUMBER

### 220 ITEM IDENTIFICATION INFORMATION

### 222 FIRST ITEM

### 224 SECOND ITEM

### 226 THIRD ITEM

### 230 DIGEST VALUE

### 300 REFERENCE INFORMATION

### 310 PRODUCT IDENTIFICATION INFORMATION

### 320 ITEM IDENTIFICATION INFORMATION

### 330 DIGEST VALUE

### 400 REFERENCE SCREEN

### 410 AREA

### 420 AREA

### 430 SEARCH BUTTON

### 440 AREA

### 442 FIRST ITEM

### 444 SECOND ITEM

### 446 THIRD ITEM

### 448 MANUFACTURING PROCESS INFORMATION

### 450 DOWNLOAD BUTTON

### 500 SCREEN

### 510 AREA

### 520 AREA

### 521 DATE

### 522 STEP

### 523 STEP DELIVERABLE

### 524 PERSON IN CHARGE

### 525 WORK TYPE

### 526 STATUS

### 527 RECORD

### 530 SEARCH BUTTON

### 600 SCREEN

### 610 AREA

### 620 AREA

### 622 MARK

### 630 AREA

### 640 AREA

### 1000 COMPUTER

### 1020 BUS

### 1040 PROCESSOR

### 1060 MEMORY

### 1080 STORAGE DEVICE

### 1100 INPUT/OUTPUT INTERFACE

### 1120 NETWORK INTERFACE

### 2000 MANAGEMENT SYSTEM

### 2100 REGISTRATION APPARATUS

### 2120 ACQUIRING UNIT

### 2140 SAVING UNIT

### 2200 REFERENCE APPARATUS

### 2220 ACQUIRING UNIT

### 2240 OUTPUTTING UNIT

### 2300 STORAGE UNIT

What is claimed is:

1. A registration apparatus comprising:
at least one memory that is configured to store instructions; and
at least one processor that is configured to execute the instructions to:
acquire identification information of a product to be registered, identification information of an item related to a manufacturing process, and manufacturing process information related to the item among the manufacturing process information related to the manufacturing process of the product;
compute a digest value of the acquired manufacturing process information; and
put the computed digest value in a storage unit in association with the acquired identification information of the product and the acquired identification information of the item.

2. The registration apparatus according to claim 1,
wherein the manufacturing process information is data of a procedure manual that defines a procedure of a work related to manufacturing of the product, data indicating that the manufacturing process of the product complies with a guideline, or data indicating a record of a work performed in the manufacturing process of the product.

3. A reference apparatus comprising:
at least one memory that is configured to store instructions; and
at least one processor,
wherein the reference apparatus is communicably connected to a storage unit, the storage unit storing, in association with identification information of a product and identification information of an item related to a manufacturing process, a digest value of the manufacturing process information related to the item among the manufacturing process information related to the manufacturing process of the product,
wherein the at least one processor that is configured to execute the instructions to:
acquire the identification information of the product to be referenced; and
output reference information by which it can determine, for one or more of the items, whether or not the digest value of the manufacturing process information is stored in the storage unit in association with the identification information of the item and the identification information of the product to be referenced.

4. The reference apparatus according to claim 3,
wherein the manufacturing process information is data of a procedure manual that defines a procedure of a work related to manufacturing of the product, data indicating that the manufacturing process of the product complies with a guideline, or data indicating a record of a work performed in the manufacturing process of the product.

5. The reference apparatus according to claim 3,
wherein the at least one processor that is configured to execute the instructions further to:
determine the identification information of each of a plurality of the items that can be associated with the identification information of the product to be referenced; and
output the reference information for each of the determined items.

6. The reference apparatus according to claim 3,
wherein the at least one processor that is configured to execute the instructions further to:
acquire the identification information of the item to be referenced; and
output the reference information for the acquired identification information of the item to be referenced.

7. A registration method executed by a computer comprising:
acquiring identification information of a product to be registered, identification information of an item related to a manufacturing process, and manufacturing process information related to the item among the manufacturing process information related to the manufacturing process of the product;
computing a digest value of the acquired manufacturing process information; and
putting the computed digest value in a storage unit in association with the acquired identification information of the product and the acquired identification information of the item.

8. The registration method according to claim 7,
wherein the manufacturing process information is data of a procedure manual that defines a procedure of a work related to manufacturing of the product, data indicating that the manufacturing process of the product complies with a guideline, or data indicating a record of a work performed in the manufacturing process of the product.

9. A reference method executed by a computer,
wherein the computer is communicably connected to a storage unit, the storage unit storing, in association with identification information of a product and identification information of an item related to a manufacturing process, a digest value of the manufacturing process information related to the item among the manufacturing process information related to the manufacturing process of the product,
wherein the reference method comprising:
acquiring the identification information of the product to be referenced; and
outputting reference information by which it can determine, for one or more of the items, whether or not the digest value of the manufacturing process information is stored in the storage unit in association with the identification information of the item and the identification information of the product to be referenced.

10. The reference method according to claim 9,
wherein the manufacturing process information is data of a procedure manual that defines a procedure of a work related to manufacturing of the product, data indicating that the manufacturing process of the product complies with a guideline, or data indicating a record of a work performed in the manufacturing process of the product.

11. The reference method according to claim 9, further comprising:
determining the identification information of each of a plurality of the items that can be associated with the identification information of the product to be referenced; and
outputting the reference information for each of the determined items.

12. The reference method according to claim 9, further comprising:
acquiring the identification information of the item to be referenced; and
outputting the reference information for the acquired identification information of the item to be referenced.

13-20. (canceled)
